(19) United States
(12) Patent Application Publication
(10) Pub. No.: US 2024/0149629 A1
(43) Pub. Date: May 9, 2024

(54) AIR SUSPENSION SYSTEM FOR MOTOR VEHICLE

(71) Applicant: ARNOTT, LLC, Merritt Island, FL (US)

(72) Inventors: Mark TURNER, Merritt Island, FL (US); Daniel LEONE, Merritt Island, FL (US); Bradley MENDEN, Merritt Island, FL (US)

(21) Appl. No.: 18/348,098

(22) Filed: Jul. 6, 2023

Related U.S. Application Data
(60) Provisional application No. 63/423,595, filed on Nov. 8, 2022.

(51) Int. Cl. B60G 17/019; B60G 17/016; B60G 17/048

(52) U.S. Cl. CPC B60G 17/019; B60G 17/0161; B60G 17/048; B60G 2202/152; B60G 2204/4308; B60G 2204/45; B60G 2400/204; B60G 2400/252; B60G 2500/202; B60G 2500/30; B60G 2600/14

(57) ABSTRACT

An air spring is configured for use in connection with a motor vehicle. The air spring includes a first end cap. The first end cap is configured to attach to a first vehicle component. The air spring also includes a piston member. The piston member is configured to attach to a second vehicle component. The piston member is movable toward and away from the first end cap in an axial direction during use. The air spring also includes an air sleeve that is coupled to the first end cap at a first end by use of a first crimp ring and to the piston member at a second end by use of a second crimp ring to form a chamber configured to receive pressurized air. The air spring further includes a transition collar that is configured to placed radially outward from either the first or second crimp ring. The transition collar includes a sloped or tapered exterior surface that allows a portion of the air sleeve to engage and roller over the exterior surface of the transition collar to reduce wear to the air sleeve.

### PRIORITY CLAIM

This application claims priority under 35 U.S.C. § 119(e) to U.S. Provisional Application Ser. No. 63/423,595 filed Nov. 8, 2022, which is expressly incorporated herein by reference in its entirety.

### BACKGROUND

The present disclosure relates to suspension systems and particular to vehicle suspension systems used on motor vehicles. Off-road vehicles, such as those made by Jeep™ for example, typically use leaf springs or coil springs in combination with shock absorbers. A vehicle suspension system is a protective lattice of shock-absorbing components such as springs and dampers. The vehicle suspension is adapted to absorb the energy from various bumps and other kinetic impacts while on-road or off-road. Furthermore, it helps the tires of the vehicle stay in contact with the road.

Factory suspension systems typically do not provide the requisite level of ground clearance needed to take a vehicle off road. Typical aftermarket suspension kits, which use taller coil springs to increase vehicle ground clearance change the ride and handling characteristics of the vehicle as well as increase the center of gravity of the vehicle. While the aftermarket coil suspension kits increase ground clearance to assist when driving off road, they raise the overall vehicle height, which can make it difficult or impossible to pass under structures such as trees or low parking garages.

### SUMMARY

In accordance with the present disclosure, a vehicle suspension system is shown as part of a vehicle.

In illustrative embodiments, the vehicle suspension system can be retrofitted onto an existing vehicle factory equipped with a coil spring suspension without permanent alterations to the original vehicle components or can come as original equipment as supplied by the vehicle manufacturer. The vehicle suspension system includes a compressor, air tank, controller, processor, air lines, wiring, sensors, air springs, and shocks to replace the factory coil springs.

In illustrative embodiments, front air springs include a piston member, and an air sleeve that is secured to the piston member at a first end and to a base member at a second end.

The piston member includes a first and second recesses. The first recess is configured to fit over an existing bump stop tube of the vehicle without removing the bump stop tube. The front air spring is configured to fit between and be secured to upper and lower spring perches of the vehicle.

In illustrative embodiments, rear air springs are configured to be positioned between upper and lower perches of the vehicle. Rear air springs include a top member, a lower piston member and an air sleeve coupled to the top member and the piston member. In order to prevent binding and premature wear to the rear air springs, the top member and the piston member are configured to create an internal angle in the air springs to permit proper linear movement of the rear air springs.

In illustrative embodiments, the air springs include profiled pistons that are configured to work with the air sleeve to optimize ride performance and reducing bottoming. The profiled piston acts as a progressive spring to control air sleeve roll and suspension movement during extending suspension travel.

In illustrative embodiments the air springs include pressure valves that maintain a selected minimum air pressure in the air springs from about 15 psi to about 30 psi and preferably from about 15 psi to about 20 psi.

In illustrative embodiments, the air spring includes an annular sleeve that is positioned adjacent the crimp ring of the lower end of the air sleeve that includes a cam surface to allow the air sleeve to roll over the annular sleeve to reduce air sleeve failure and provide stability at lower pressures.

In illustrative embodiments, the air spring system is configured to automatically adjust the air springs to auto level the vehicle when traveling over a predetermined vehicle speed and permit vehicle height adjustment below a predetermined speed.

In illustrative embodiments, the air spring system is configured to auto level the vehicle above a predetermined speed by systematically adjusting individual air springs to level the vehicle and allow for over the air updates or flashing to the vehicle ECU to cause an increase in vehicle default height over stock vehicle height.

The foregoing summary is illustrative only and is not intended to be in any way limiting. In addition to the illustrative embodiments and features described herein, filthier aspects, embodiments, objects and features of the disclosure will become fully apparent from the drawings and the detailed description and the claims.

Additional features of the disclosure will become apparent to those skilled in the art upon consideration of the following detailed description of illustrative embodiments exemplifying the best mode of carrying out the disclosure as presently perceived.

### BRIEF DESCRIPTION OF THE DRAWINGS

The foregoing and other features of the present disclosure will become more fully apparent from the following description and appended claims, taken in conjunction with the accompanying drawings. In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the drawing, can be arranged, substituted, combined, and designed in a wide variety of different configurations, all of which are explicitly contemplated and make part of this disclosure.

The detailed description particularly refers to the accompanying figures in which:

FIG. 1 is a is a side elevational view of a vehicle lift equipped with the air suspension system and including an arrow to indicate that the vehicle height can be selectively raised and lowered by the user of the vehicle;

FIG. 2 is a perspective view of a front suspension of a vehicle showing a coil spring positioned between upper and lower spring perches;

FIG. 3 is a perspective view of a front suspension of a vehicle showing a shock absorber and a coil spring aligned with upper and lower spring perches and illustrating a bump stop tube located within the coil spring and extending downward from the upper spring perch;

FIG. 4 is a perspective view of an air spring of the air suspension system positioned between the upper and lower spring perches of the motor vehicle in place of the coil spring and bump stop;

FIG. 5 is a perspective view of the lower portion of the air spring positioned on the lower spring perch of the motor vehicle and showing the air sleeve portion of the air spring secured to the air spring base by use of a lower crimp ring;

FIG. 6 is a perspective view of the upper spring perch of the front suspension showing an air line of the air suspension system, used to supply air to one of the front air springs, passing through a plug that has been fitted into an existing opening formed in the upper spring perch;

FIG. 7 is a side elevational view of an upper portion of the front air spring for a vehicle showing an air line coming in from the top of the air spring;

FIG. 8 is a sectional view of the front air spring taken along line 8-8 of FIG. 7 and illustrating a piston member having a bump stop at its lower end, a boot surrounding the piston, an air spring base member, and an air sleeve extending between the piston member and the base member and further showing an air line attached to the piston and located within a cavity formed in the piston;

FIG. 9 is a perspective view of the front air spring showing the piston member, the boot surrounding the piston member, the base member and the air sleeve extending between the piston and base member and further showing the air line extending into the piston member;

FIG. 10 is an exploded view of the front air spring showing from left to right the boot, the piston member the bump stop, the air sleeve and base member;

FIG. 11 is a perspective view of the base member having a protrusion that is configured to accept one end of the air sleeve;

FIG. 12 is a top view of the base member showing a slot formed in the base member that allows for air to escape from the piston member under certain circumstances;

FIG. 13 is a sectional view of the base member taken along line 13-13 of FIG. 12 showing a recess that is configured to fit onto the lower spring perch of the vehicle;

FIG. 14 is a perspective view of the piston member of the front air spring;

FIG. 15 is a side elevational view of the piston member of the front air spring;

FIG. 16 is a sectional view of the piston member taken along line 16-16 of FIG. 15 showing a first internal cavity configured to accept the original bump stop tube extending downward from the upper spring perch of the vehicle and showing a smaller second internal cavity adapted to accept a bump stop and further showing an opening that is configured to accept the air supply line;

FIG. 17 is a perspective view of a rear air spring positioned between upper and lower spring perches at the rear of the vehicle showing an air sleeve positioned above and coupled to a piston member;

FIG. 18 is a perspective view of a portion of a rear suspension showing a coil spring between upper and lower spring perches;

FIG. 19 is a perspective view of a portion of a rear suspension showing an upper spring perch;

FIG. 20 is a perspective view of an upper portion of the rear air spring position within the upper spring perch;

FIG. 21 is a perspective view of the rear air spring showing the top mount, the air sleeve, and the piston member;

FIG. 22 is an exploded view of the rear air spring showing the top mount, the air sleeve, and the piston member;

FIG. 23 is a side elevational view of the rear air spring in the expanded position;

FIG. 24 is a side elevational view of the rear air spring in the contracted position;

FIG. 25 is a side elevational view of a first embodiment of a piston member of the rear air spring showing that the base of the piston member is at an angle with respect to the top of the piston;

FIG. 26 is a top view of the piston member of the rear air spring of FIG. 25;

FIG. 27 is a sectional view of the piston member taken along line 27-27 of FIG. 26 showing that the base of the piston member is at an angle with respect to the top of the piston and showing first and second inner cavities;

FIG. 28 is a diagrammatic view of the air suspension system installed in a vehicle;

FIG. 29 is a side elevational view of the rear air spring showing that the centerline of the air sleeve is not perpendicular to the upper surface of the top member or the lower surface of the piston member

FIG. 30 is another perspective view of the front suspension of the vehicle shown the front air spring secured to the vehicle;

FIG. 31 is another perspective view of the rear suspension of the vehicle shown the rear air spring secured to the vehicle;

FIG. 32 is a perspective view of a front coil spring suspension;

FIG. 33 is a perspective view of a rear coil spring suspension;

FIG. 34 is a section view of another embodiment of a rear air spring showing a second embodiment of a piston member;

FIG. 35 is a section view of a front air spring;

FIG. 36 is a top plan view of a vehicle frame showing the location of the electronics and wiring for the system; and

FIG. 37 is a top plan view of a vehicle frame showing the location of the air suspension components and air lines for the system;

### DETAILED DESCRIPTION

The following detailed description is directed to certain specific embodiments of the technology. In this description, reference is made to the drawings wherein like parts or steps may be designated with like numerals throughout for clarity. Reference in this specification to “one embodiment,” “an embodiment,” or “in some embodiments” means that a particular feature, structure, or characteristic described in connection with the embodiment is included in at least one embodiment of the invention. The appearances of the phrases “one embodiment,” “an embodiment,” or “in some embodiments” in various places in the specification are not necessarily all referring to the same embodiment, nor are separate or alternative embodiments necessarily mutually exclusive of other embodiments. Moreover, various features are described which may be exhibited by some embodiments and not by others. Similarly, various requirements are described which may be requirements for some embodiments but may not be requirements for other embodiments.

Various embodiments of an air spring are described herein which are constructed of a flexible air sleeves. Air sleeves or bellows as used herein refers to its usual and customary meaning and includes without limitation a component or components of an air spring that forms a flexible sidewall or sidewalls of the air spring, and may be in a straight or substantially straight configuration relative to a longitudinal axis thereof, such as a sleeve arrangement. The air sleeve is joined, for example circumferentially joined, at top and bottom ends to an end-cap and piston, respectively, which may be non-flexible. The end cap and piston may include one or more pneumatic couplings for adding or releasing an amount of gas within the air spring. The end cap and piston include attachments for mechanically affixing the air spring to components, such as a vehicle or machine in which the air spring is to be used.

Various embodiments described herein relate to an air spring bellows for an air spring. The air spring may be used in suspension systems for automobiles, trucks, buses, trains, and industrial machines, among other applications. The air spring includes an air sleeve or bellows. The air sleeve includes a flexible elastomeric substrate.

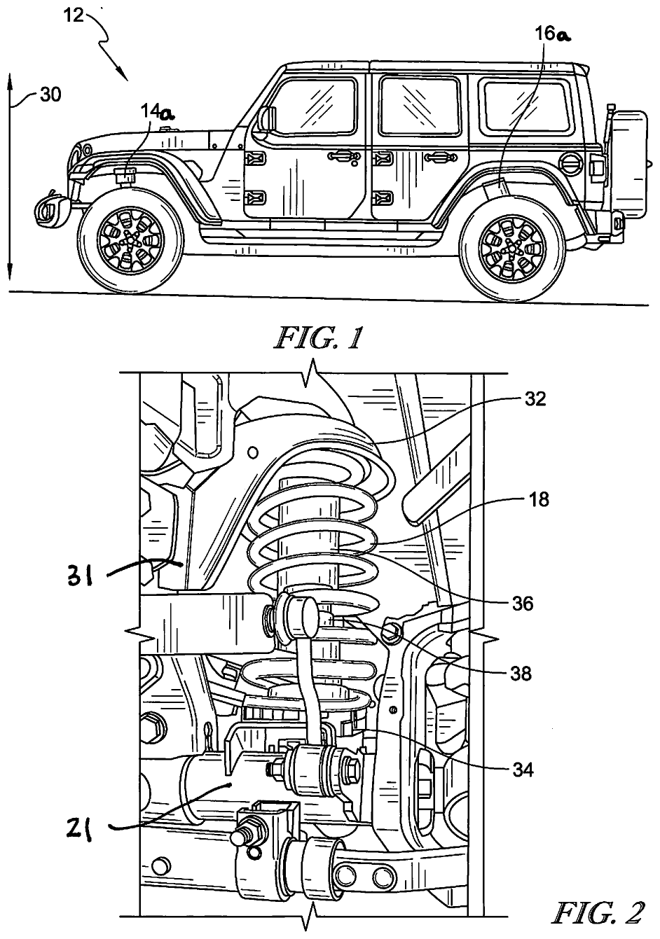

In illustrative embodiments, an air suspension system 10 is adapted to be either retrofitted onto a vehicle 12 that was factory equipped with a coil spring suspension or fitted as an original equipment manufacturer (OEM) product that allows a vehicle user to raise and lower the vehicle 12 from within the vehicle or remotely, as shown, for example, in FIG. 1. The air suspension system 10 includes front and rear air springs 14a, 14b, 16a, 16b that replace existing coil springs 18 found in motor vehicles, as shown in FIGS. 1 & 28, and other figures. The air suspension system 10 also includes a compressor 20, an air tank 22, a controller 24 with processor, and a valve block 25. The air suspension system 10 can be installed on a factory Jeep® Wrangler® equipped with coil springs 18, for example or installed during manufacture of the vehicle. The air spring system 10 allows the user to customize their vehicle ride height from within the vehicle and is equipped with vehicle auto leveling over a preset speed. Above a preset speed, the system 10 is designed to auto adjust the air springs 14a, 14b, 16a, 16b to level the vehicle with solid axles or one having an independent suspension.

The air suspension system 10 also includes the front and rear air springs 14a, 14b, 16a, 16b and front and rear ride height sensors 26a, 26b, 28a, 28b that are used by the controller 24 to determine vehicle ride height at each corner of the vehicle 12, as shown in FIG. 38. The air suspension system 10 has been designed to allow the front and rear air springs 14a, 14b, 16a, 16b to replace existing coil springs 18 without requiring major alterations to factory vehicle components, such as cutting or welding frame and suspension components. This arrangement allows a less experienced do it yourselfer (DIY) to install the air suspension system on their vehicle to replace the factory coil spring setup without the need for expensive cutting and welding equipment.

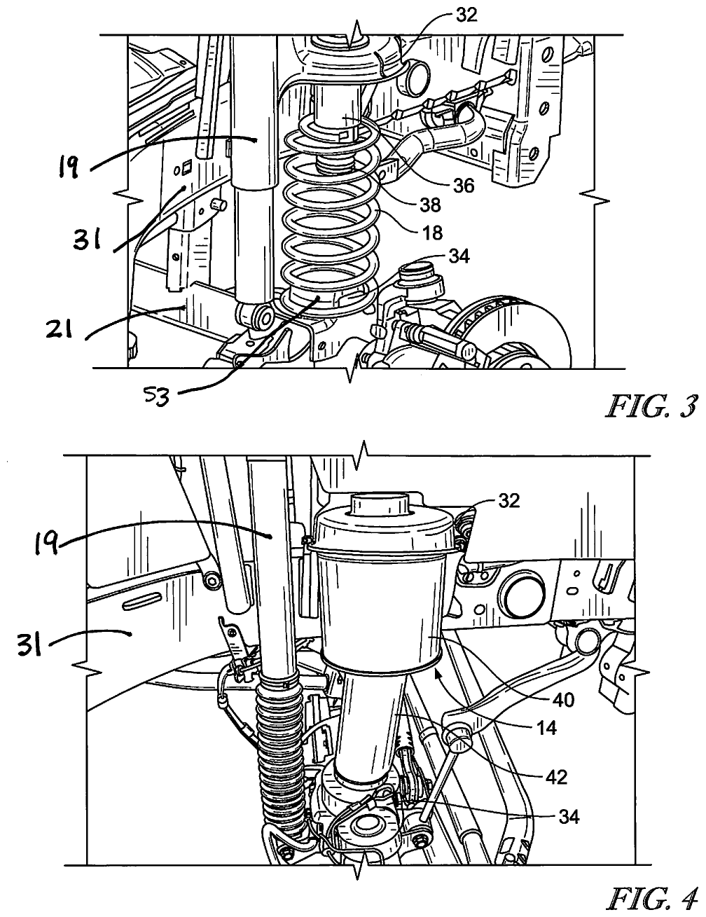

The air suspension system 10 is configured to be fitted onto a vehicle 12 and includes front and rear air springs 14a, 14b, 16a, 16b, as shown in FIGS. 1 and 38. Air suspension system 10 allows the vehicle operator to either raise or lower the vehicle 12 as indicated by arrow 30. Air suspension system 10 can also control vehicle pitch, roll as well as individual wheel position to assist in maintaining wheel contact with the ground surface. A factory vehicle front vehicle suspension, such as the kind found on a Jeep Wrangler, for example, typically comprises a coil spring 18 positioned between upper and lower spring perches 32, 34, as shown in FIGS. 2 and 3. A shock absorber 19 is typically located outside of the coil spring 18 and is used to dampen movement of the axle 21. Coil spring 18 extends between axle 21 and the frame 31 of the vehicle 12 to absorb axle movement caused by uneven surfaces. Positioned within coil spring 18 is a bump stop tube 36 that is coupled to the upper perch 32, typically by welding, and extends downwardly toward lower perch 34. Bump stop tube 36 includes a bump stop bushing 38 coupled to the lower end of the bump stop tube 36. The bump stop tube 36 is a permanent vehicle component in a Wrangler and can only be removed by cutting it out of the vehicle 12. Bump stop tube 36 is designed to limit travel of the axle 21 by engaging with lower spring perch 34 when the suspension is at the end of its travel and bottomed out.

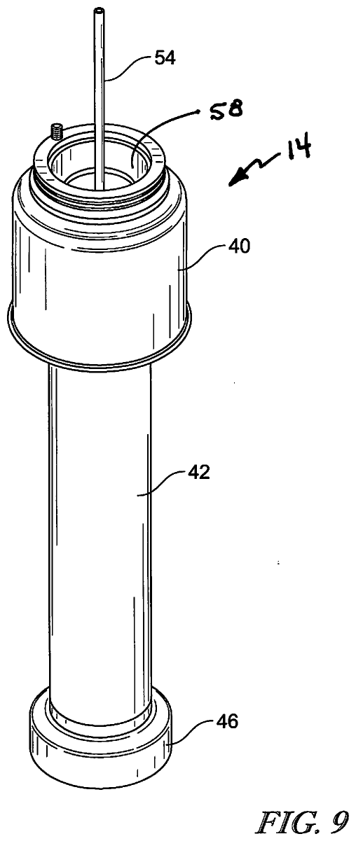

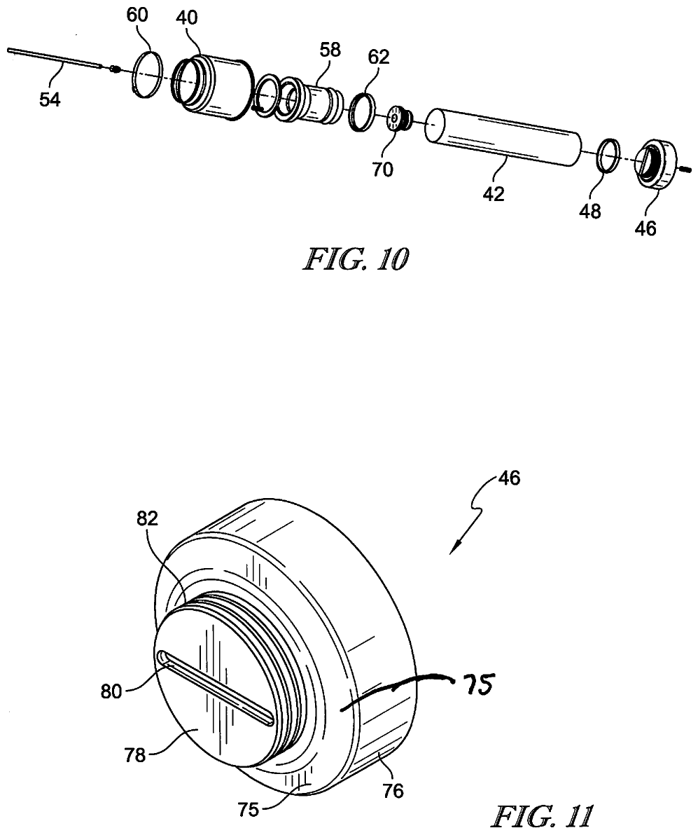

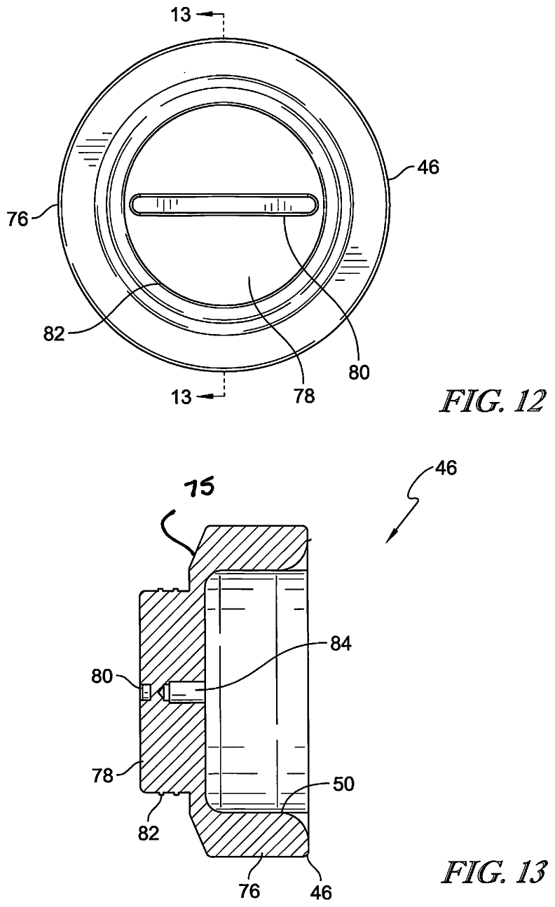

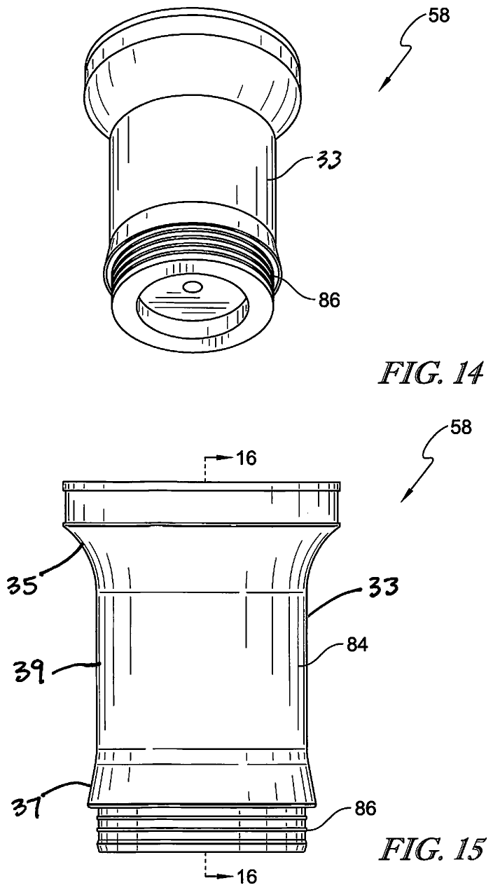

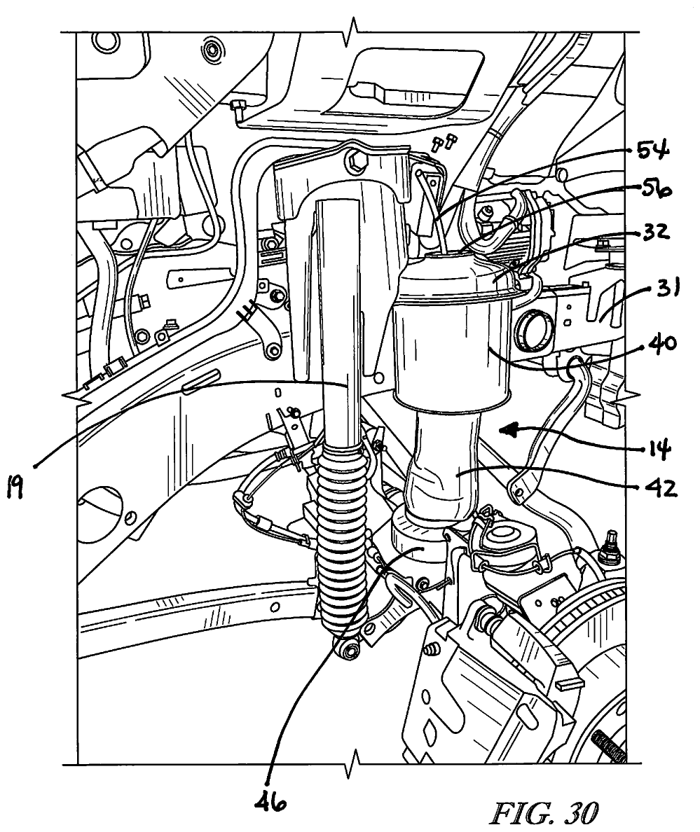

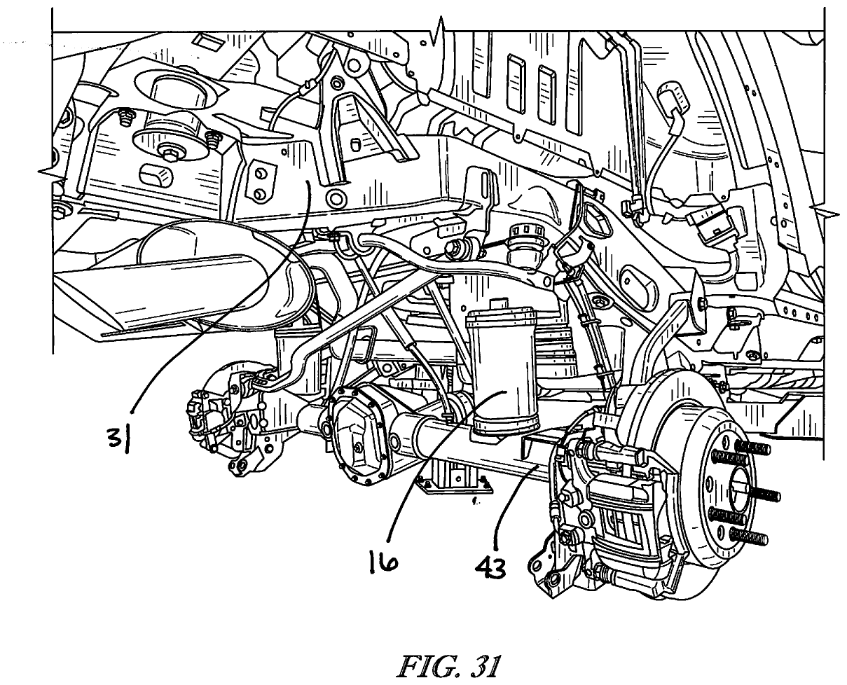

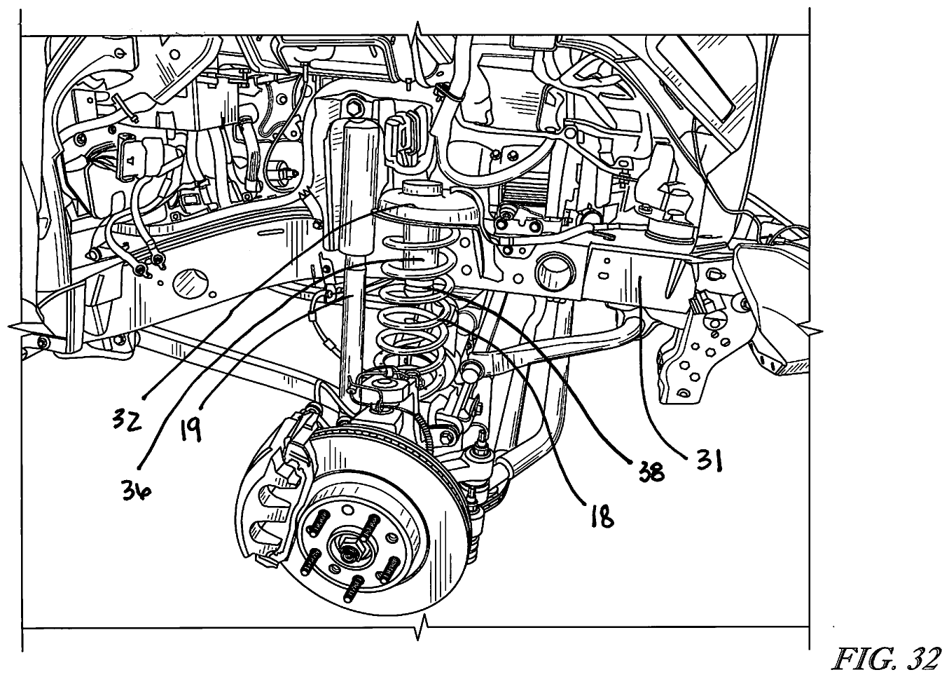

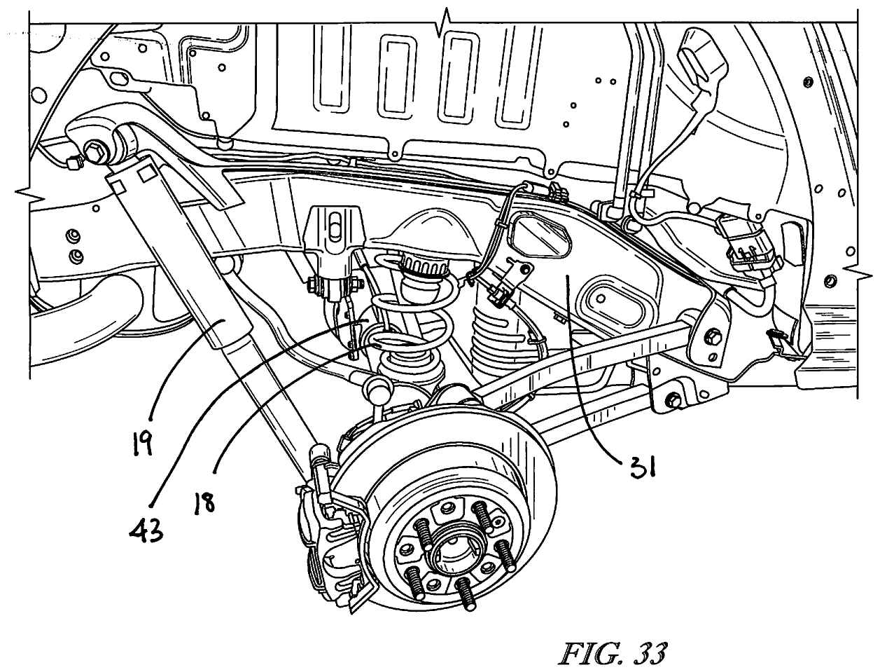

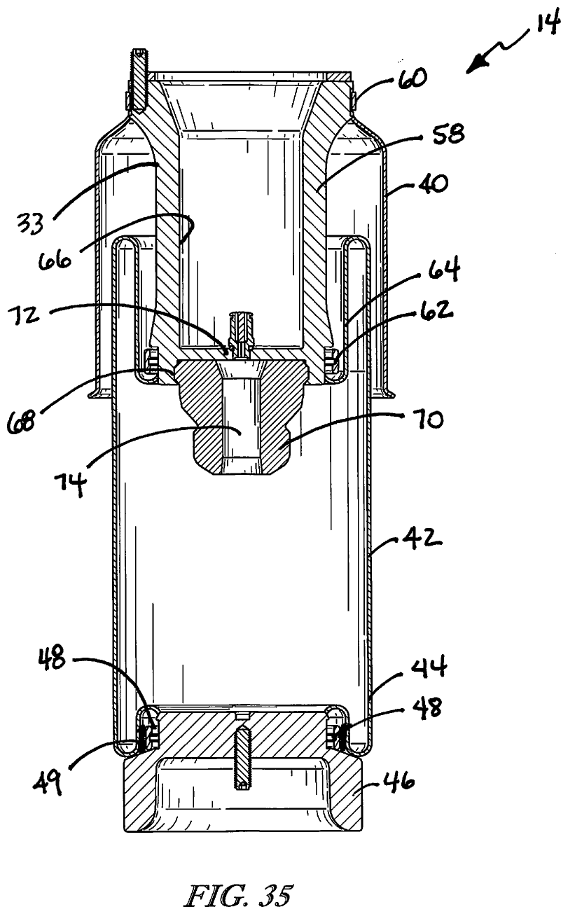

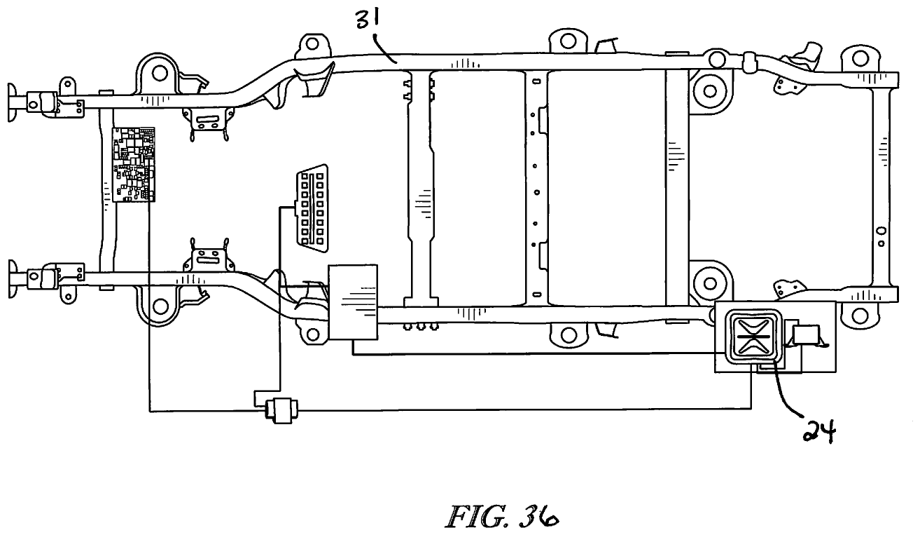

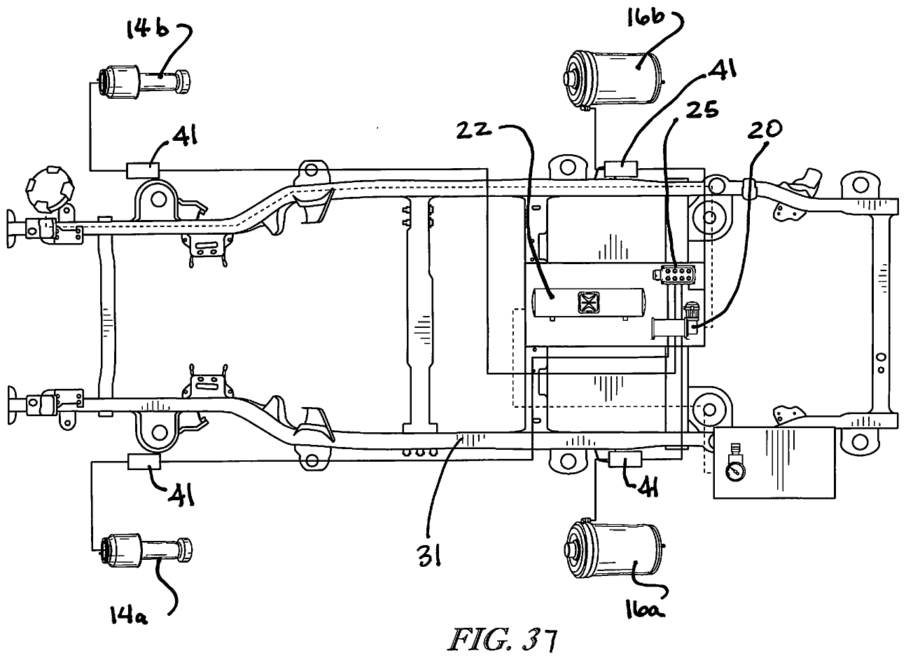

Air suspension system 10 includes front air springs 14a, 14b, which are illustrated in FIGS. 4-16, 30 and 35. A pair of front air springs 14a, 14b are used on the front of the vehicle 12. Front air springs 14a, 14b of the present disclosure are configured to replace existing coil springs 18 without major vehicle modification or can be installed as factory equipment. Front air springs 14a, 14b are positioned between upper and lower spring perches 32, 34, as shown in FIG. 4. Front air springs 14a, 14b includes boot 40 used to protect the air springs. Air is supplied to front air springs 14a, 14b from the top of upper spring perch 32, as will be further illustrated and described herein.

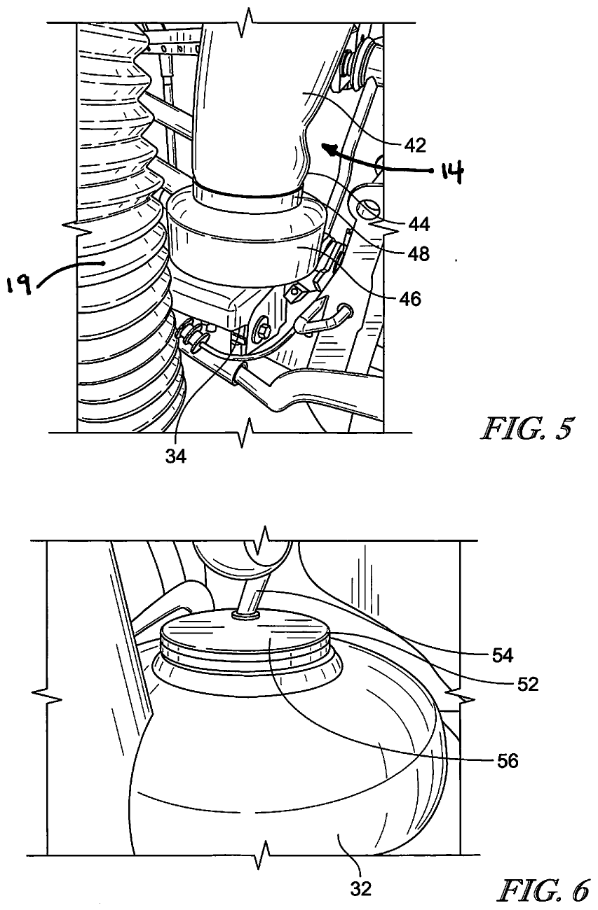

Air sleeve 42 of front air springs 14a, 14b is secured at a lower end 44 to a base member 46 of front air springs 14a, 14b by a first crimp ring 48, as shown in FIGS. 4 and 5. First crimp ring 48 creates an air tight seal between air sleeve 42 and base member 46, as shown in FIG. 5. Lower perch 34 of vehicle 12 includes an upward protrusion 53. Base member 46 includes a recess 50 that is configured to fit over the upward protrusion 53 of lower perch 34, as shown in FIGS. 3 & 8. Upper perch 32 of vehicle 12 is formed to include a central opening 52 that leads into bump stop tube 36, as shown in FIGS. 3 & 6. Air lines 54 from system valve block 25 supplies pressurized air to front air springs 14a, 14b through central opening 52. Central opening is sealed from water and particulate matter by use of plug 56.

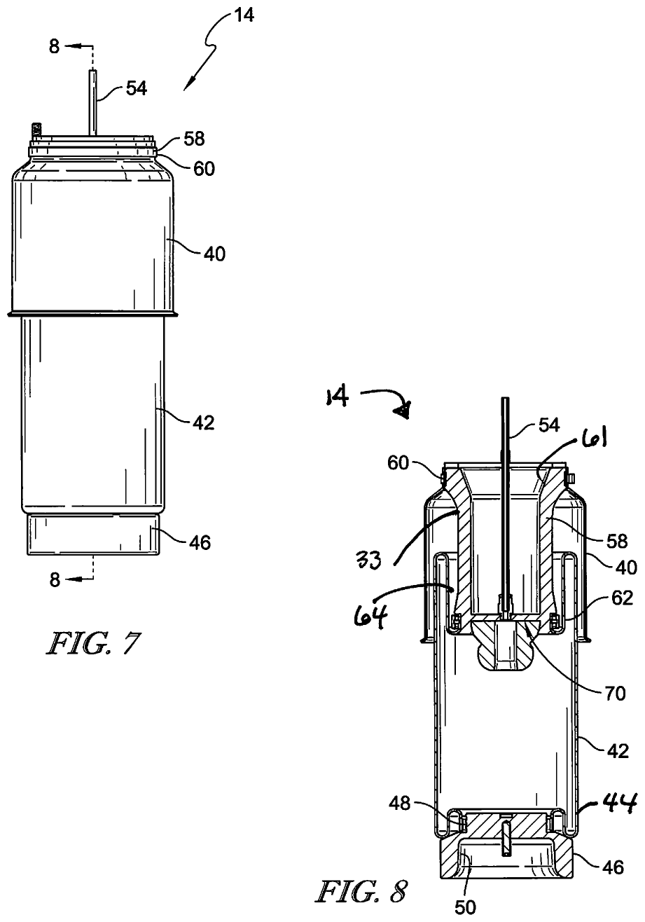

Front air springs 14a, 14b each include a piston member 58 and boot 40, which is secured to piston member 58 by a second crimp ring 60, as shown in FIGS. 7, 8, & 35. Piston member 58 has a curved exterior profile 33 that creates a progressive spring rate as air springs 14a, 14b are extended and retracted during use. The use of a curved piston profile to create a progressive spring rate provides stability in the air springs 14a, 14b when they are extended so that vehicle handling is not adversely affected when riding in a lifted position.

Air sleeve 42 of front air spring 14 is secured to base member 46 by first crimp ring 48 at lower end 44 and to piston member 58 by a third crimp ring 62 at an upper end 64, as shown in FIGS. 8 & 35. Front air springs 14a, 14b also include an annular collar 49. Annular collar 49 is coaxial with and radially outward from first crimp ring 48. Annular collar 49 is configured to cause air sleeve 42, during compression of front air springs 14a, 14b, to roll over annular collar 49 and down base member 46 during movement of air sleeve 42. Annular collar 49 is configured to significantly reduce air sleeve failure and adds stability to air springs 14a, 14b to improve handling of vehicle 12 under low pressure conditions.

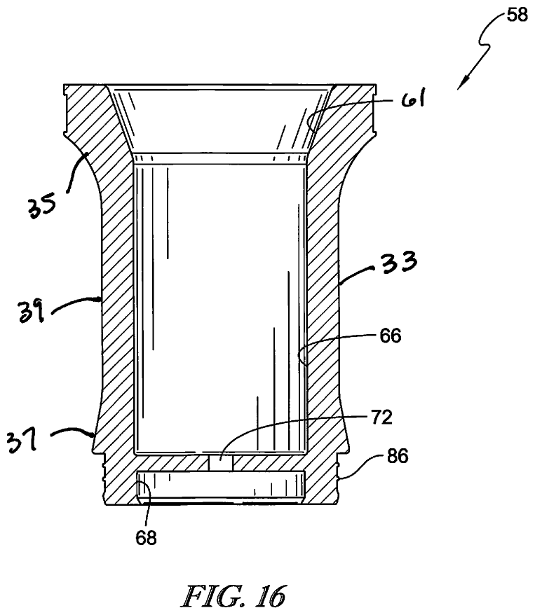

Piston member 58 includes a first central recess 66 that opens toward the top of piston member 58 and a shallower second central recess 68 that opens toward the bottom of the piston member 58, as shown in FIGS. 16 & 35. First central recess 66 is configured to accept and house bump stop tube 36 of vehicle 12 within the recess in its entirety without removing the original tube when front air springs 14a, 14b are secured to vehicle 12. The original bump stop bushing 38 do need to be removed from vehicle 12 before installing front air springs 14a, 14b.

Piston member 58 includes a bump stop member 70 that is adapted to engage base member 46 in the event first air spring 14 were to become fully collapsed (bottomed out), as shown in FIGS. 8-10 and 35. Piston member 58 is also formed to include aperture 72 that is adapted to accept air line 54. Bump stop member 70 includes a central opening 74 to allow air from air line 54 to enter air sleeve 42 through piston member 58. While bump stop member 70 is illustrated coupled to piston member 58 it could also be coupled to base member 46. A portion of air sleeve 42 fits within boot 40 and rolls upon itself between piston member 58 and boot 40. Front air spring 14 is, in essence, a column of air confined within the rubber-and-fabric container air sleeve 42 that is shaped like a bellows. The spring action of air spring 14 results from the compression, expansion and movement of the air sleeve 42 about contoured piston member 58.

Piston member 58 includes an exterior side wall profile 33, as shown in FIGS. 8, 15, 16 and 35. Side wall profile 33 includes a center portion 39 having a first diameter, an upper portion 35 having a second diameter and a lower portion 37 having a third diameter. The upper and lower portions 35, 37 have a diameter that is greater than the center portion 39 to create a rolling surface for air sleeve 42 to create a progressive spring rate for air springs 14a, 14b to improve vehicle handling and stability. Upper portion 35 and lower portion 37 may have the same diameters or can have different diameters. Sidewall profile 33 is curved as it transitions between upper portion 35, through center portion 39 to lower portion 37. The diameter of the upper portion 35 is greater than the center portion 39 to increase air sleeve 42 rigidity as air pressure within front air springs 14a, 14b is decreased improving air spring stability.

Piston member 58 includes a grooved recessed portion 86 that is adapted to accept third crimp ring 62 and upper end 64 of air sleeve 42. Piston member 58 includes first central recess 66 and second central recess 68 that are fluidly connected by aperture 72. Aperture 72 is adapted to accept air line 54, as shown in FIG. 8. Central recess 66 includes a cone shaped tapered region 61 that assists with aligning central recess 66 with bump stop tube 36 when installing front air spring 14 onto bump stop tube 36 of vehicle 12. Piston member 58 is configured to be mechanically fastened to upper perch 32. Both ends of front air spring 14 are secured to upper and lower perches 32, 34 with fasteners so that front air spring 14 maintains its position in the event the front suspension is fully extended and front air spring 14 has low air pressure (air spring load is not enough to retain the spring).

Base member 46 of front air spring 14 is shown, for example, in FIGS. 11-13. Base member 46 includes a base wall 75, annular side wall 76, and a projection 78 extending from base wall 75. Projection 78 includes a grooved sidewall 82 that is adapted to accept lower end 44 of air sleeve 42 and first crimp ring 48. Projection 78 is also formed to include slotted groove 80 that allows air to escape from bump stop member 70 in the situation where bump stop member 70 is in contact with base member 46. Alternatively, bump stop member 70 can also include a groove or opening to allow air to escape from bump stop member 70. Base member 46 can also include an opening or passageway to allow air to enter chamber in the event bump stop member 70 comes into contact with base member 46. Base member 46 also includes recess 50 that is adapted to accept projection 53 from lower perch 34 of vehicle 12. Base member 46 further includes a threaded bore 84 that is adapted to accept a fastener to secure base member 46 to lower perch 34.

Each front air spring 14a, 14b includes an in-line residual pressure valve 41 that is connected to the air line 54 coupled to front air spring 14a, 14b. Residual pressure valve 41 is configured to maintain a minimum air pressure within the front air springs 14a, 14b to provide stability to the air springs. Residual pressure valves 41 are configured to maintain minimum air spring pressure in the springs from about 15 psi to about 30 psi and preferably from about 15 psi to about 25 psi and more preferably at about 20 psi. Residual pressure valve 41 prevents under pressurization of air springs to maintain minimal operation to allow for improved vehicle control and stability at lower air spring pressures.

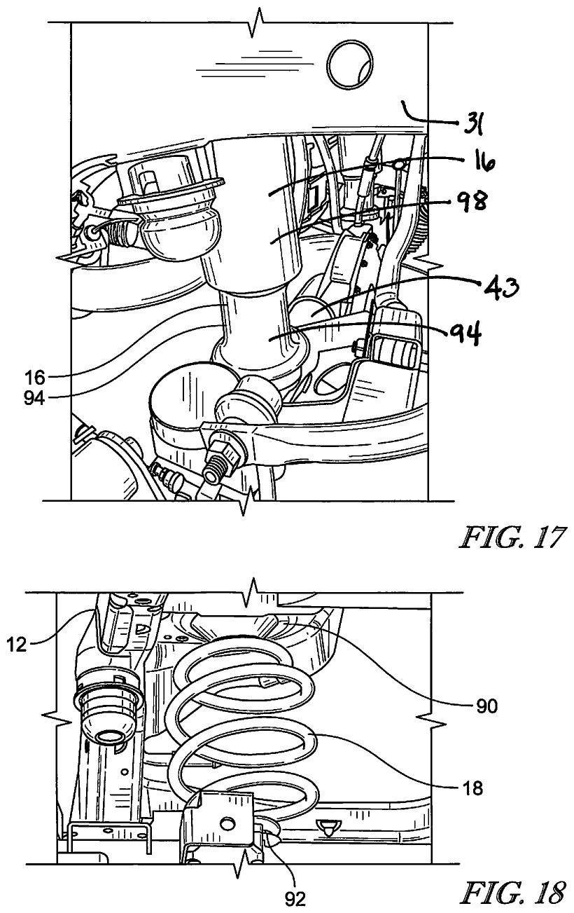

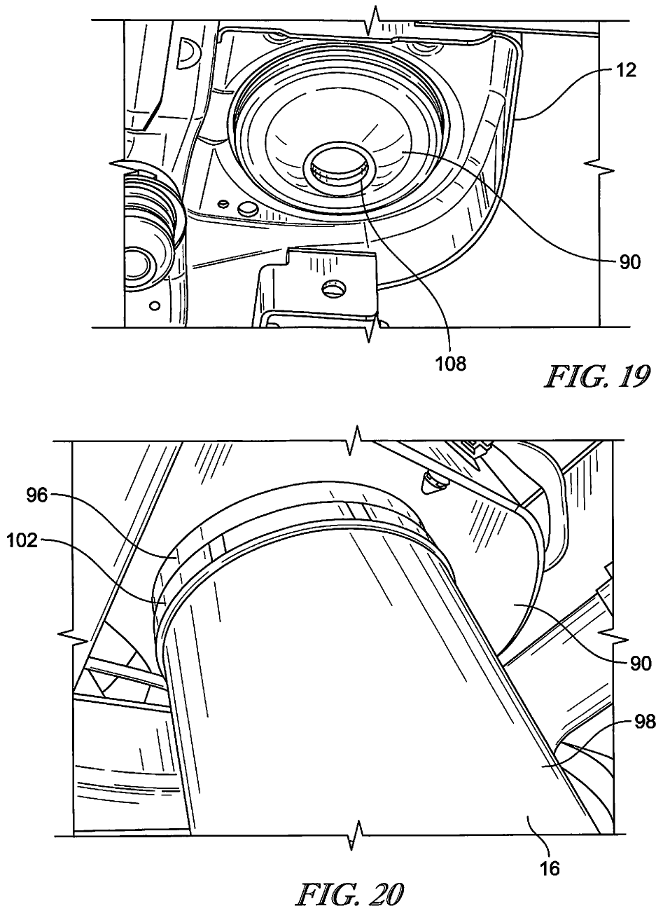

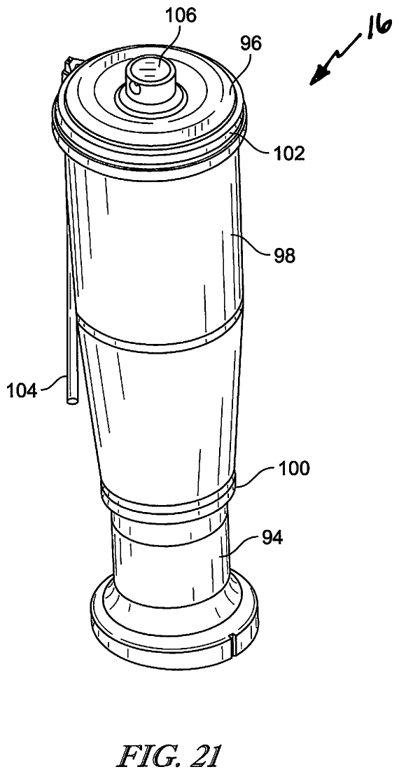

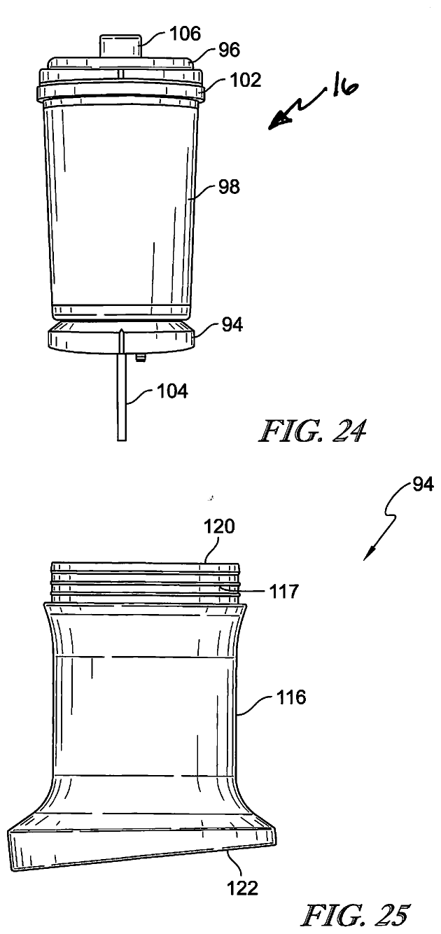

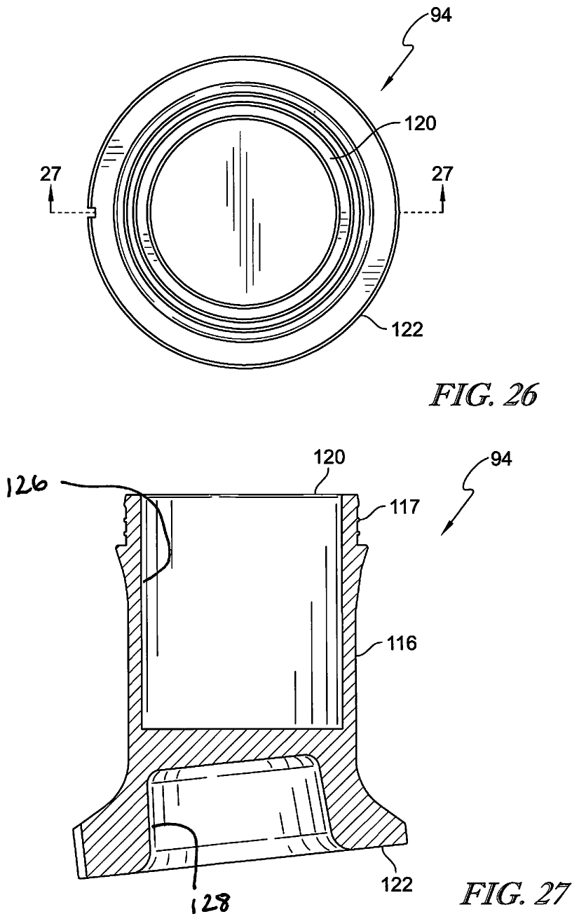

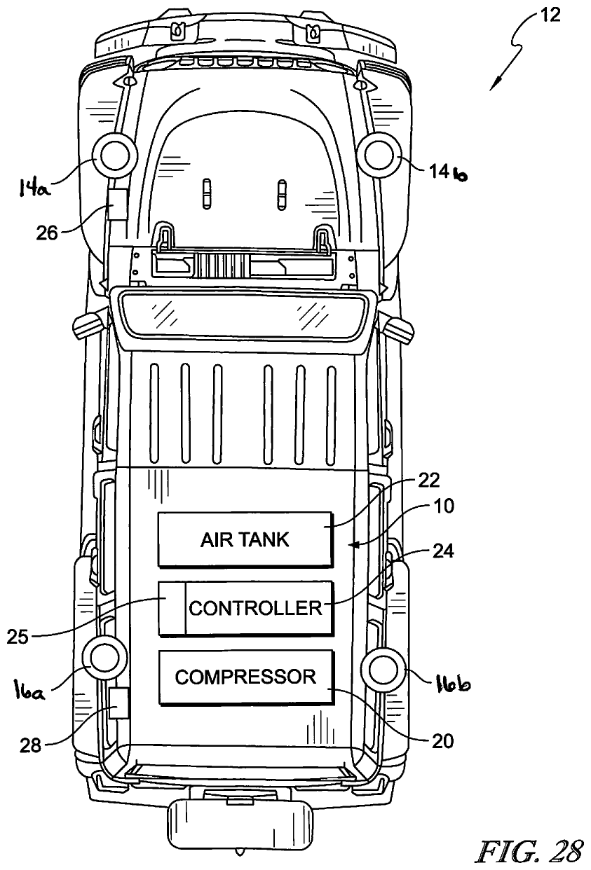

Air suspension system 10 also includes two rear air springs 16a, 16b that are installed in place of coil springs 18 on vehicle 12, as shown in FIGS. 17-27. Rear air springs 16a, 16b are configured to be positioned between upper and lower perches 90, 92 of vehicle 12. Rear air springs 16a, 16b are positioned between the rear axle 43 and the vehicle frame 31 and are configured to replace standard coil springs. Rear air springs 16a, 16b include a top member 96 that is adapted to engage with upper perch 90 and includes an upward projection 106 that engages aperture 108 formed in upper perch 90, as shown in FIGS. 19 and 21. Top member 96 includes an aperture 110 that is configured to accept air line 104 and further includes an internal passageway (not shown) that allows air to enter air sleeve 98 to allow for inflation and deflation of air sleeve 98.

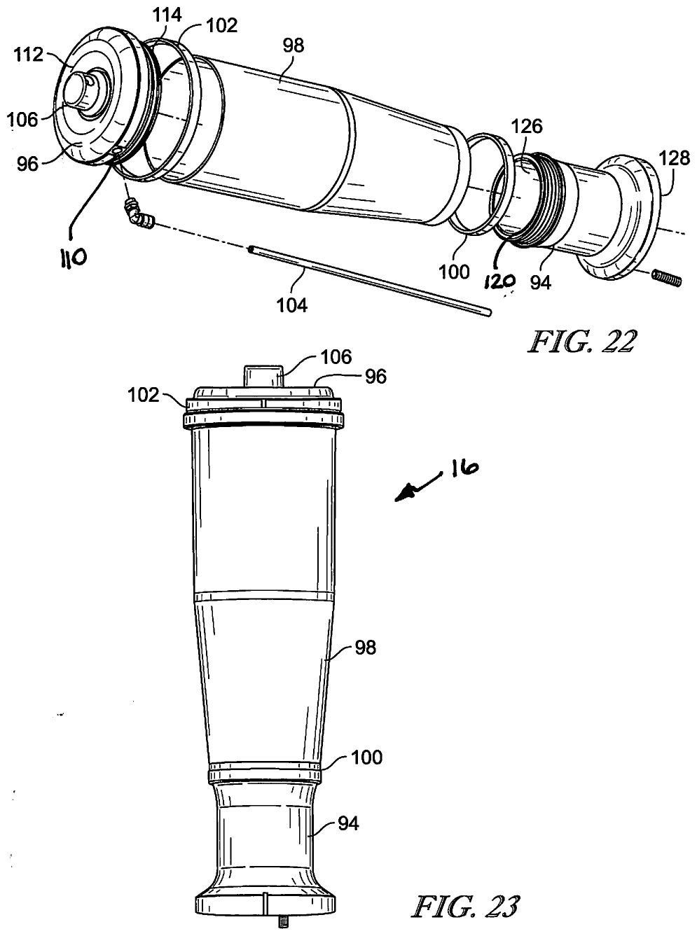

Top member 96 includes a top surface 112 and a spaced apart bottom surface 114, as shown in FIG. 22. Bottom surface 114 is not parallel with top surface 112 but is at a 2-6 degree angle to the top surface but preferably at a 3 degree angle to prevent internal rubbing of air sleeve 98 and misalignment of air sleeve 98 during use when the axle 43 is moving with respect to the frame 45. Misalignment is due to vehicle axle/spring perch articulation during rear suspension travel as suspension travel on a solid axle is not linear but has a curvilinear path as axle moves with vehicle control arms.

Each rear air spring 16a, 16b includes residual pressure valve 41 that is connected to the air line 104 coupled to an air spring 16a, 16b. Residual pressure valve 41 is configured to maintain a minimum air pressure within the air spring 16a, 16b to provide stability to the air springs. Residual pressure valve 41 is configured to maintain minimum air spring pressure from about 15 psi to about 30 psi and preferably from about 15 psi to about 25 psi and more preferably at about 20 psi. Residual pressure valve 41 prevents under pressurization of air springs to maintain minimal operation to allow for improved vehicle control and stability at lower pressures.

Piston member 94 of rear air spring 16 includes a side wall 116 that is formed to include a recessed grooved portion 117 that is adapted to accept air sleeve 98 and first crimp ring 100 and creates an air tight seal with air sleeve 98, as shown in FIGS. 22, and 25-27. Piston member 94 includes a top surface 120 and a spaced apart bottom surface 122. Bottom surface 122 is not parallel with top surface 120 but is at a 2-6 degree angle but preferably at a 3 degree angle 124 to prevent biding of air sleeve 98 during use. Rear suspension geometry of vehicle 12 causes rear axle of vehicle to pivot and rotate with respect to the vehicle frame.

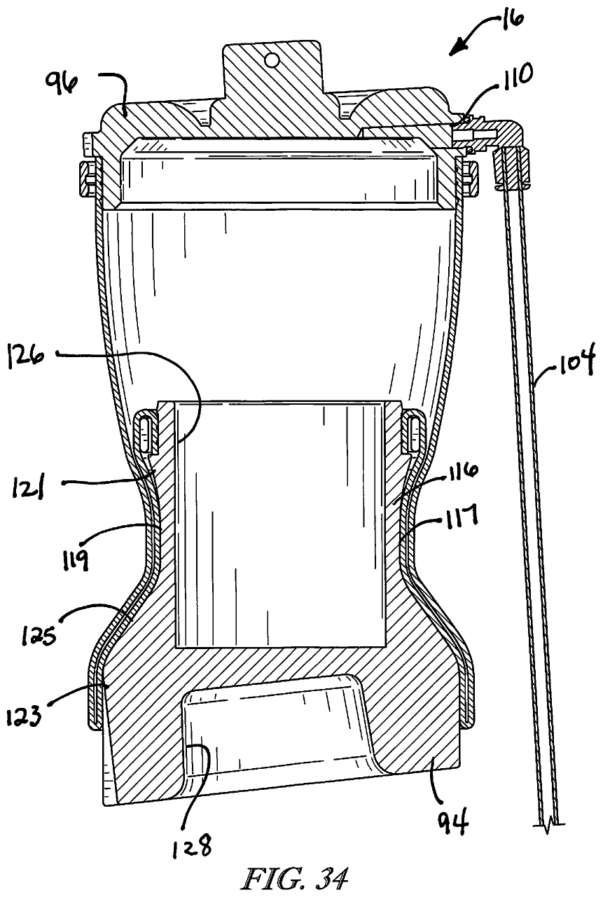

Piston member 94 of air springs 16a, 16b includes an exterior side wall profile 117, as shown in FIG. 34. Side wall profile 117 includes a center portion 119 having a first diameter, an upper portion 121 having a second diameter and a lower portion 123 having a third diameter. The upper and lower portions 121, 123 each include a diameter that is greater than the center portion 119 to create a progressive spring rate for air spring 16a, 16b as air sleeve 98 moves to improve vehicle handling and stability. Upper portion 121 and lower portion 123 may have different diameters. Sidewall profile 117 includes transition zone 125 that is curved as it transitions between center portion 119 to lower portion 123. Side wall profile 117 of side wall 116 has an hourglass type shape to allow air sleeve 98 to roll along the profile 117 as air spring is compressed and moves along piston member 94. This arrangement creates a progressive spring rate to allow consistent spring rate pressure over the entire range of movement of the air spring. The air springs 16a, 16b will have consistent spring rate at different vehicle heights selected by the user and during movement of the air spring to improve stability of air springs.

The exterior profile of piston member 94 has been designed to provide a progressive rate for the air springs 16a, 16b so that the vehicle handling characteristics are improved when a vehicle, such as a Jeep, is lifted. With the progressive air spring design, the vehicle handling characteristics are more similar to the stock vehicle verses a typical lifted vehicle that uses coil springs. The increase in diameter of piston member 94 from the center portion 119 of the piston profile to the lower portion 123 is from about a 38% to about 52% increase in diameter and preferably from about a 40% to about 50% increase in diameter. Also, the transition angle in transition zone 125 between the center portion 119 of the piston 94 to the lower portion 123 of the piston 94 is from about 48 degrees to about 64 degrees and preferably from about 50 degrees to about 62 degrees. At low pressures the air sleeve 98 of the air springs 16a, 16b has a portion that is located in the center portion 119 of the piston and the air sleeve 98 is doubled up in thickness at this location to provide for additional air sleeve 98 wall support. At low pressures, air sleeve 98 rolls along lower portion 123 and transition zone 125 to prevent unwanted wear to air sleeve 98. As air springs 16a, 16b are extended, air sleeve 98 rolls along center portion 119, which allows end of air sleeve 98 to roll along a reduced diameter portion of piston 94.

In order to prevent binding and premature wear to rear air spring 16, due to solid axle range of movement, top member 96 and/or piston member 94 are angled with respect to the centerline of the air springs to create an internal angle from about 4 degrees to about eight degrees but is preferably six degrees with respect to upper and lower contact surfaces of perches 90, 92 so that air springs internally move linearly along the longitudinal axis of the springs. The internal angle can be accomplished by adding an angle to bottom surface 122 of piston member 94 or by adding a three degree angle to piston member 94 so that the total internal angle with respect to the perches is approximately six degrees. Piston member 94 is also formed to include a first cavity 126 and a spaced apart second cavity 128. Second cavity 128 is adapted to fit over a raised portion of lower perch 92. First cavity 126 is used to increase overall internal chamber volume of rear air spring 16. Side wall 116 of piston member 94 is configured to allow air sleeve 98 to roll down side wall 116 as a result of vehicle 12 being lowered or the air springs being compressed during use.

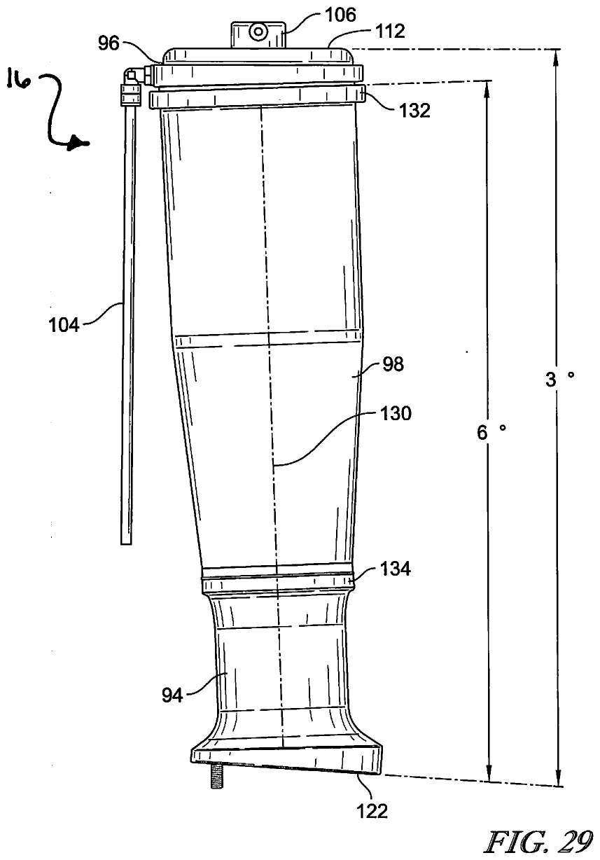

FIG. 29 illustrates a side elevational view of the rear air spring 16 showing that the centerline of the air sleeve 98 is not perpendicular to the upper surface 112 of the top member 96 and/or the lower surface 122 of the piston member 94. Center line of air sleeve 98 is collinear with first air sleeve mount 132 and the second air sleeve mount 134, which are the portions of the top member 96 and piston member 94 in which the air sleeve 98 is coupled. Upper surface 112 is at approximately a 3 degree angle to lower surface 122 and lower surface 122 is at approximately a 6 degree angle to first air sleeve mount 132. With this arrangement, the air springs compress and expand linearly even though movement of the axle with respect to the frame of the vehicle is not linear. This arrangement reduces wear to the air springs as they are used in the vehicle.

In use, a user acquires air suspension system 10 and installs air tank 22, controller 24, with processor, valve block 25, and compressor 20 in their vehicle 12. Depending on application, it may also be necessary to install updated control arms and shock absorbers. Controller 24 is wired to the vehicle electrical system and air lines are routed from the compressor 20 to the valve block 25 and air tank 22. Front and rear air springs 14a, 14b, 16a, 16b are next installed on the vehicle 12 in place of the factory coil springs. Air springs 14a, 14b, 16a, 16b are designed to be installed without requiring the user to make major modifications to the vehicle, which means that the vehicle can returned to factory condition if the vehicle owner decided to do so.

Air lines 54, 104, which include residual pressure valves 41, are next routed from valve block 25 to each of the four air springs 14a, 14b, 16a, 16b and to air tank 22. Next, vehicle height sensors 26a, 26b, 28a, 28b are installed onto the vehicle so that the controller can receive feedback as to vehicle height at each corner of the vehicle. Once the system is installed, it is run through a calibration mode where the controller utilizes sensors 26, 28 to detect the maximum and minimum height of the vehicle by a user pressurizing and depressurizing air springs 14a, 14b, 16a, 16b so they fully extend and retract. Once the system 10 is calibrated, a user can selectively raise and lower all or a portion of vehicle 12 from a first to a second elevation or any number of elevations. For example, a user can select to raise the vehicle one inch over stock vehicle height or four inches over stock vehicle height. User can also select to lower the vehicle one inch below stock vehicle height, for example. The system can also be configured so that a vehicle equipped with the air suspension system 10 can be adjusted by using over-the-air-updates or by flashing the vehicle ECU. The system is designed so that a new vehicle that includes the air suspension system 10 and sold at a stock vehicle height can be adjusted to add, for example, one or two inches of vehicle height over stock height at a dealership by flashing the ECU or by performing an over the air update. In this scenario, the vehicle owner would bring their stock height vehicle back to the dealership and the dealer could add one to two inches of height to the vehicle by flashing the vehicle or suspension system ECU or performing an over-the-air-update. The vehicle would then be returned to the vehicle owner at a new height elevated above the stock height. The vehicle owner would pay the dealership for performing the suspension height upgrade.

The air suspension system 10 has been specifically configured to work with vehicles equipped with solid axles. Some vehicles, such as the Jeep Wrangler have solid front and rear axles. Other vehicles, such as the Ford® Bronco® may include an independent front suspension and a solid axle rear suspension. The air suspension system 10 is configured to auto level the vehicle 12 over a preset speed and is configured to work with the vehicle to maintain wheel contact with ground surface when driving on uneven terrain.

At speeds over a preset speed, such as 25 mph, the air suspension system will auto level the vehicle 12 so that all four corners of the vehicle are at the same selected height. To auto level the vehicle 12, the system 10 takes readings at each height sensor 26a, 26b, 28a, 28b to determine the vehicle height at each corner of the vehicle. Once a height determination has been made, the system 10 will increase or decrease air pressure at specific air springs 14a, 14b, 16a, 16b in an attempt to level the vehicle. Once the air pressure has been changed in the air springs (increased or decreased), a second vehicle height measurement is taken at each corner of the vehicle by the system. The system is designed to adjust (raise or lower) one air spring at a time and retake height measurements to determine whether the adjustment to the single air spring leveled out the vehicle.

If the vehicle height is level within a specified tolerance range, the system maintains the set air pressure in the air springs 14a, 14b, 16a, 16b. If the vehicle level is not within the specified tolerance range, then the system will again increase or decrease air pressure at specified air springs 14a, 14b, 16a, 16b and take additional height measurements and repeat until the vehicle is level. The system is designed to add or subtract a preset volume of air to/from the air springs 14a, 14b, 16a, 16b depending on how far from level the vehicle is at a specified corner of the vehicle. For example, if the system 10 has determined that the right front corner of the vehicle is lower than the other corners of the vehicle by an inch, for example, the system 10 would increase air pressure in the left front air spring 14a by 2.5 psi, for example, and then take another height reading to determine whether the vehicle 12 is now level. If it is determined that the vehicle is still not level, the system 10 would further increase the pressure in the left front air spring 14a by another incremental amount (such as another 2.5 psi) and retake the height measurement until its level. Air pressure increases/decreases are made incrementally until the vehicle becomes level.

The air suspension system 10 is designed to work to level the vehicle when the vehicle is not level due to an uneven load placed on the vehicle. As an example, in a situation where left front of the vehicle is actually lower than the right front of the vehicle the system 10 determines whether the left front of the vehicle is lower than the right side of the vehicle by taking readings at the height sensors. In this situation, the right front air spring 14b will be extended further than the left front air spring 14a. The determination by the system is accomplished by taking first height measurements of the right front height sensor 26b and the left front sensor 26a and comparing the values.

If the system 10 determines the right front height sensor 26b has a greater measurement than the left front height sensor 26a, the system next incrementally increases the air pressure in the left front air spring 14a from a first air pressure to a second air pressure to extend (telescope) the left front air spring 14a outward. The system 10 then makes a second height measurement of the left front height sensor 26b. If the second height measurement of the left front height sensor 26b did not change to equal the measurement initially taken at the right front height sensor 26a, the system 10 again incrementally increases the air pressure in the left front air spring 14a from the second pressure to a third pressure. The system 10 then takes a third height measurement from the left front height sensor 26b.

If the system determines that the third height measurement equals the initial height measurement taken at the right front height sensor 26a, the system stops adding air to the left front air spring 14a. If the system determines that the third height measurement is still less than the initial height measurement taken at the right front height sensor 26a, the system again incrementally increases air pressure in the left front air spring 14a and then takes a fourth height measurement using the left front height sensor 26b and compares it to the third height measurement. If the fourth height measurement is equal to the initial height measurement taken at the right front height sensor 26a the system stops adding air to the left front air spring 14a.

The system 10 then incrementally decreases the air pressure in the right front air spring 14b and then takes a fifth height measurement of the right front height sensor 26b and compares it to the fourth height measurement. If the difference between measurements did not change, the system 10 maintains the current air pressure in the air springs 14a, 14b. The system 10 is designed to make single vehicle corner height adjustments at a time as a change of height on one side of a solid axle can affect the opposite side of the solid axle.

The system 10 makes numerous measurements and adjustments per minute in order to best level the vehicle 12. Without repeating the discussion of the process steps, the system 10 also makes similar adjustments to the rear air springs 16a, 16b, in the event there is an uneven load at the rear of the vehicle. The system 10 evaluates one side of the axle at a time and makes adjustments to one air spring at a time in order to level the rear of the vehicle with the ground.

Whether to either raise or lower an air spring depends on whether that corner of the vehicle is either above or below the preset height of the vehicle. If the system is set for a 2″ vehicle lift and the right rear corner of the vehicle is at 1.5″ (due to a load in the right rear of the vehicle) and the left rear corner of the vehicle is at the 2″ lift height, the system will increase air pressure to the right rear air spring to raise the right rear corner of the vehicle. After air is added the right rear air spring, the system takes a height measurement to determine whether the right rear corner of the vehicle is at the 2″ lift height. If the right rear of the vehicle is at the 2″ lift height then the system takes a height measurement of the left rear to determine whether it is still at the 2″ lift height, if it is not, the system will then either increase or decrease the air pressure in the left rear air spring so that it at the 2″ lift height. The system 10 is designed to only adjust one air spring on an axle at a time as adjustment to one side may affect the other side of the axle.

Various features of the invention have been particularly shown and described in connection with the illustrative embodiment of the invention, however, it must be understood that these particular arrangements may merely illustrate, and that the invention is to be given its fullest interpretation within the terms of the appended claims.

It will be appreciated by those skilled in the art that various modifications and changes may be made without departing from the scope of the described technology. Such modifications and changes are intended to fall within the scope of the embodiments. It will also be appreciated by those skilled in the art that parts included in one embodiment are interchangeable with other embodiments; one or more parts from a depicted embodiment may be included with other depicted embodiments in any combination. For example, any of the various components described herein and/or depicted in the figures may be combined, interchanged or excluded from other embodiments.

Any processes or steps of any flow charts described and/or shown herein are illustrative only. A person of skill in the art will understand that the steps, decisions, and processes embodied in the flowcharts described herein may be performed in an order other than that described herein. Thus, the particular flowcharts and descriptions are not intended to limit the associated processes to being performed in the specific order described.

With respect to the use of substantially any plural and/or singular terms herein, those having skill in the art may translate from the plural to the singular and/or from the singular to the plural as is appropriate to the context and/or application. The various singular/plural permutations may be expressly set forth herein for sake of clarity.

It will be understood by those within the art that, in general, terms used herein are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

The term “comprising” as used herein is synonymous with “including,” “containing,” or “characterized by,” and is inclusive or open-ended and does not exclude additional, unrecited elements or method steps.

All numbers expressing quantities of ingredients, reaction conditions, and so forth used in the specification and claims are to be understood as being modified in all instances by the term “about.” Accordingly, unless indicated to the contrary, the numerical parameters set forth in the specification and attached claims are approximations that may vary depending upon the desired properties sought to be obtained by the present invention. At the very least, and not as an attempt to limit the application of the doctrine of equivalents to the scope of the claims, each numerical parameter should be construed in light of the number of significant digits and ordinary rounding approaches.

The above description discloses several methods and materials of the present invention. This invention is susceptible to modifications in the methods and materials, as well as alterations in the fabrication methods and equipment. Such modifications will become apparent to those skilled in the art from a consideration of this disclosure or practice of the invention disclosed herein. Consequently, it is not intended that this invention be limited to the specific embodiments disclosed herein, but that it cover all modifications and alternatives coming within the true scope and spirit of the invention as embodied in the attached claims.

What is claimed is:

1. A method for adjusting a vehicle suspension on a vehicle provided with at least one solid axle and having a first air spring and first ride height sensor located proximate a first end of the axle and a second air spring and second ride height sensor located proximate a second end of the axle, the method comprising:
taking first height measurements from the first and second ride height sensors and comparing the two measurements;
increasing air pressure in the first air spring from a first pressure to a second pressure if the first height measurement taken at the second ride height sensor is greater than the first height measurement taken at the first ride height sensor;
taking a second height measurement from the second ride height sensor and comparing the second height measurement to the first height measurement of the second ride height sensor;
increasing the air pressure in the first air spring from the second pressure to a third air pressure if the second height measurement is the approximately the same as the first height measurement of the second ride sensor;
taking a third height measurement from the second ride height sensor and comparing the third height measurement to the second height measurement of the second ride height sensor;
increasing the air pressure in the first air spring from the third air pressure to a fourth air pressure if the third height measurement is the approximately the same as the fourth height measurement of the second ride sensor or maintaining the air pressure in the first air spring if the third height measurement is greater than the second height measurement.

2. The method of claim 1, further including the step of taking a fourth height measurement from the second ride height sensor and comparing the fourth height measurement to the third height measurement of the second ride height sensor.

3. The method of claim 2, further including the step of increasing the air pressure in the first air spring from the fourth air pressure to a fifth air pressure if the fourth height measurement is the approximately the same as the third height measurement of the second ride sensor.

4. The method of claim 1, wherein the vehicle suspension of the vehicle is only adjusted according to the method above a preset vehicle speed.

5. The method of claim 4, wherein when the vehicle is moving above the preset vehicle speed the system auto levels the vehicle.

6. The method of claim 5, wherein a user of the vehicle can raise or lower the entire vehicle to two or more suspension heights to move the vehicle closer or away from the ground.

7. A vehicle suspension system for a motor vehicle having at least one solid axle, the system comprising:
first and second front air springs and first and second front ride height sensors located at the front half of the vehicle, the front air springs configured to absorb impact forces from front wheels of the vehicle;
first and second rear air springs and first and second ride height sensors located at the back half of the vehicle, the rear air springs configured to absorb impact forces from rear wheels of the vehicle;
an air tank, a compressor configured to supply air to the air tank,
a valve system coupling the air tank to the front and rear air springs;
a controller electrically coupled to the valve system and the front and rear height sensors;
wherein the controller is configured to:
take first height measurements from the front ride height sensors and compare the two measurements;
increase air pressure in the first front air spring from a first pressure to a second pressure if the first height measurement taken at the first front ride height sensor is greater than the measurement taken at the second front ride height sensor;
take a second height measurement from the first front ride height sensor and compare the second height measurement to the first height measurement of the first front ride height sensor;
increasing the air pressure in the first front air spring from the second pressure to a third air pressure if the second height measurement is the approximately the same as the first height measurement of the first front ride sensor;
taking a third height measurement from the first front ride height sensor and comparing the third height measurement to the second height measurement of the first front ride height sensor;
increasing the air pressure in the first front air spring from the third air pressure to a fourth air pressure if the third height measurement is the approximately the same as the fourth height measurement of the front ride sensor or maintaining the air pressure in the first front air spring if the fourth height measurement is greater than the third height measurement.

8. The vehicle suspension system of claim 7, wherein the controller is further configured to:
take first height measurements from the rear ride height sensors and comparing the two measurements;
increase air pressure in the first rear air spring from a first pressure to a second pressure if the first height measurement taken at the first rear ride height sensor is less than the measurement taken at the second rear ride height sensor;
take a second height measurement from the first rear ride height sensor and comparing the second height measurement to the first height measurement of the first rear ride height sensor;
increasing the air pressure in the first rear air spring from the second pressure to a third air pressure if the second height measurement is less than the first height measurement of the first rear ride sensor;
taking a third height measurement from the first rear ride height sensor and comparing the third height measurement to the second height measurement of the second rear ride height sensor;
increasing the air pressure in the first rear air spring from the third air pressure to a fourth air pressure if the third height measurement is less than the second height measurement of the first rear ride sensor or maintaining the air pressure in the first rear air spring if the third height measurement is the same as the second height measurement.

9. A vehicle suspension system for a motor vehicle having at least one solid axle, the system comprising:
first and second front air springs and first and second front ride height sensors located at the front half of the vehicle, the front air springs configured to absorb impact forces from front wheels of the vehicle;
first and second rear air springs and first and second ride height sensors located at the back half of the vehicle, the rear air springs configured to absorb impact forces from rear wheels of the vehicle;
an air tank, a compressor configured to supply air to the air tank,
a valve system coupling the air tank to the front and rear air springs;
a controller electrically coupled to the valve system and the front and rear height sensors;
wherein the controller is configured to:
take first height measurements from the rear ride height sensors and comparing the two measurements;
increase air pressure in the first rear air spring from a first pressure to a second pressure if the first height measurement taken at the first rear ride height sensor is less than the measurement taken at the second rear ride height sensor;
take a second height measurement from the first rear ride height sensor and comparing the second height measurement to the first height measurement of the first rear ride height sensor;
increasing the air pressure in the first rear air spring from the second pressure to a third air pressure if the second height measurement is the approximately the same as the first height measurement of the first rear ride sensor;
taking a third height measurement from the first rear ride height sensor and comparing the third height measurement to the second height measurement of the first rear ride height sensor;
increasing the air pressure in the first rear air spring from the third air pressure to a fourth air pressure if the third height measurement is the less than the second height measurement of the first rear ride sensor or maintaining the air pressure in the first rear air spring if the third height measurement is approximately the same as the second height measurement.

10. An air spring for a motor vehicle having fully extended and retracted positions, the air spring comprising:
a piston member having a side wall;
a base member movable independent of the piston member;
an air sleeve coupled to the piston member at a first end and to the base member at a second end to form a chamber;
a bump stop associated with the piston member and positioned with the chamber;
wherein the bump stop is configured to engage with the base member when the air spring is in a fully collapsed position.

11. The air spring of claim 10, wherein the piston member is configured to accept an air line.

12. The air spring of claim 11, wherein the bump stop includes an opening to allow air from the air line to pass through the bump stop.

13. The air spring of claim 12, wherein one of the base member or the bump stop includes a recess that is adapted to allow air to pass out of the opening of the bump stop when base member is in contact with the bump stop.

14. The air spring of claim 10, wherein the air spring is coupled to a valve that maintains a minimum air pressure within the chamber of the air spring.

15. An air spring for a motor vehicle, the air spring comprising:
an upper member having a first surface configured to engage with a portion of the motor vehicle;
a piston member movable independent of the upper member, the piston member having a second surface configured to engage with a portion of the motor vehicle;
an air sleeve coupled to the piston member at a first end and to the upper member at a second end to form a chamber; and
wherein one of the first surface of the upper member or the second surface of the piston member is at an angle to a center line of the air spring.

16. The air spring of claim 15 wherein the other one of the first surface of the upper member or the second surface of the piston member is at an angle to a center line of the air spring.

17. The air spring of claim 16 wherein the angle is from about 2 degrees to about 10 degrees.

18. A progressive rate air spring for use in connection with a motor vehicle, the air spring comprising:
a first end cap configured to engage to a first vehicle component;
a piston member configured to engage to a second vehicle component, the piston member movable independent of the first end cap;
an air sleeve coupled to the first end cap at a first end and to the piston member at a second end to form a chamber configured to receive pressurized air;
the piston member having an exterior contoured sidewall, the sidewall having a first region, a second region spaced axially outward from the first region, and a third region spaced axially outward from the second region;
wherein the first region includes a first diameter and the second region includes a second diameter that is less than the first diameter and the third region includes a third diameter that is greater than the second diameter, the piston further including a transition region that slopes radially outwardly from the second region to third region;
wherein when the air sleeve is configured to move along the contoured sidewall as the piston moves toward and away from the first end cap and wherein the movement of the air sleeve along the second region to the third region, through the transition region, creates a progressive change in spring rate force required to compress the air spring.

19. The air spring of claim 18, wherein the increase in diameter of piston member from the second region to the first region is from about 38% to about 52%.

20. The air spring of claim 18, wherein the increase in diameter of piston member from the second region to the first region is from about 40% to about 50% increase in diameter.

21. The air spring of claim 18, wherein the transition angle in the transition region between the second region to the first region is from about 48 degrees to about 64 degrees.

22. The air spring of claim 18, wherein the transition angle in the transition region between the second region to the first region is about 50 degrees to about 62 degrees.

23. The air spring of claim 18, wherein at low air pressures in the chamber the air sleeve includes a portion that is located in the second region of the piston.

24. The air spring of claim 23 wherein the air sleeve is doubled up in thickness in the second region of the piston.

25. The air spring of claim 18, wherein the progressive rate air spring is used in an air suspension system that is configured to increase motor vehicle height from a first height to a second height by using an over the air update or a flash to an ECU of the motor vehicle.

26. An air spring for use in connection with a motor vehicle, the air spring comprising:
a first end cap configured to attach to a first vehicle component;
a piston member configured to attach to a second vehicle component, the piston member movable toward and away from the first end cap in an axial direction during use;
an air sleeve coupled to the first end cap at a first end by use of a first crimp ring and to the piston member at a second end by use of a second crimp ring to form a chamber configured to receive pressurized air;
a transition collar that is configured to placed radially outward from either the first or second crimp ring, the transition collar having a sloped or tapered exterior surface that allows a portion of the air sleeve to engage and roller over the exterior surface of the transition collar to reduce wear to the air sleeve.

27. The air spring of claim 25, wherein the piston member includes an exterior contoured sidewall, the sidewall having a first region, a second region spaced axially outward from the first region, and a third region spaced axially outward from the second region;
wherein the first region includes a first diameter and the second region includes a second diameter that is less than the first diameter and the third region includes a third diameter that is greater than the second diameter, the piston further including a transition region that slopes radially outwardly from the second region to third region, wherein when the air sleeve is configured to roll along the contoured sidewall as the piston moves axially toward and away from the first end cap and wherein the movement of the air sleeve along the second region to the third region, through the transition region, creates a progressive change in spring rate force required to compress the air spring.
